(19) United States
(12) Patent Application Publication
(10) Pub. No.: US 2015/0121445 A1
(43) Pub. Date: Apr. 30, 2015

(54) APPARATUS AND METHOD FOR TRANSMITTING AND RECEIVING BROADCASTING

(71) Applicant: Electronics and Telecommunications Research Institute, Daejeon (KR)

(72) Inventors: Joon Young JUNG, Daejeon (KR); Dong Joon CHOI, Daejeon (KR); Namho HUR, Daejeon (KR)

(21) Appl. No.: 14/303,715

(22) Filed: Jun. 13, 2014

(30) Foreign Application Priority Data
Oct. 30, 2013 (KR) 10-2013-0130545

(51) Int. Cl. H04N 21/2362; H04N 21/2365; H04N 21/81; H04N 21/235; H04N 21/84; H04N 21/434; H04N 21/236; H04N 13/00

(52) U.S. Cl. CPC H04N 21/2362; H04N 21/23614; H04N 21/2365; H04N 13/0048; H04N 13/0059; H04N 13/0066; H04N 21/2353; H04N 21/84; H04N 21/4345; H04N 21/4347; H04N 21/4343; H04N 21/816
USPC 725/116

(57) ABSTRACT

A broadcasting transmitting apparatus configures one broadcasting channel as at least two video streams, generates a program map table (PMT) representing configuration information of a stream included within the broadcasting channel, sets a program type provided through the corresponding broadcasting channel within the PMT, multiplexes the at least two video streams and signaling information, and transmits the multiplexed two video streams and signaling information through a broadcasting network.

### CROSS-REFERENCE TO RELATED APPLICATION

This application claims priority to and the benefit of Korean Patent Application No. 10-2013-0130545 filed in the Korean Intellectual Property Office on Oct. 30, 2013, the entire contents of which are incorporated herein by reference.

### BACKGROUND OF THE INVENTION

(a) Field of the Invention

The present invention relates to an apparatus and a method for transmitting and receiving broadcasting, and more particularly, to a channel configuration and a signaling method for providing new broadcasting services, such as UHDTV and 3DTV, from a broadcasting transmitting apparatus.

(b) Description of the Related Art

Recently, as transition from analog TV to digital TV is taking place in most major advanced nations, interest in a new broadcasting service development after the digital TV service has increased. Technology development for providing a more realistic and definite new broadcasting service than a broadcasting service from the existing DTVs, such as 3DTV and UHDTV, has been conducted. However, to expand the base of the new broadcasting service, there is a need to provide the new broadcasting service while still allowing compatibility with the existing HDTV service.

Generally, the broadcasting service is largely provided based on two standard methods. An example of the two standard methods may include a video/audio compression method and transmission methods for each medium (terrestrial wave, cable, satellite, and the like). Since a digital broadcasting receiver or the DTV which is installed in a viewer's house is fabricated based on the standard methods, when a new video/audio compression method or transmission method for a new broadcasting service is introduced as a standard, the existing broadcasting receiver or the DTV may not be used. This corresponds to the case in which the analog TV is being replaced by the digital TV. Therefore, when the broadcasting standard is enacted, a lot of time and costs are required to change the enacted standard, such as the transition to digital. Therefore, this makes it hard to quickly introduce a new broadcasting service requiring a new video/audio compression method or a new transmission method.

To easily introduce new services, such as the 3DTV and UHDTV services, backward compatibility which does not affect the existing DTV service needs to be provided. The backward compatibility means providing new services without changing the existing broadcasting system, such as replacement of the receiver or the TV. For example, when the UHDTV or 3DTV service is provided through any broadcasting channel, the existing broadcasting receiver (or TV) may view the general DTV service and the new receiver (or TV) may view the UHDTV or 3DTV service.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus and a method for transmitting and receiving broadcasting capable of providing a new broadcasting service while providing backward compatibility to the existing broadcasting receiver.

An exemplary embodiment of the present invention provides a broadcasting transmitting apparatus. The broadcasting transmitting apparatus includes a first video encoder, a second video encoder, a signaling information generator, a multiplexer, and a transmitter. The first video encoder encodes a first video stream to be output as a transport stream (TS) packet;

The second video encoder encodes a second video stream to be output as a transport stream (TS) packet;

The signaling information generator generates signaling information including a program association table (PAT) which represents configuration information of a broadcasting channel and a program map table (PMT) which represents configuration information of a stream included in the broadcasting channel to be output as a TS packet. The multiplexer multiplexes the TS packets, which correspond to the first video stream, the second video stream, and the signaling information, to generate a TS corresponding to the broadcasting channel.

The transmitter transmits the TS through a broadcasting network. In this case, the PMT may include a program type provided through the broadcasting channel.

The program type may represent one of a DTV program, a 3DTV program, a UHDTV dedicated program, a DTV compatible 3DTV program, and a DTV compatible UHDTV program.

The PMT may include a descriptor loop, the descriptor loop may include a program type descriptor, and the program type descriptor may include a program type field representing the program type.

The program type descriptor may further include a program type details information field representing program type details information.

The PMT may include stream type values identifying the first video stream and the second video stream, and the signaling information generator may set the stream type value of the second video stream as a stream type value which is not recognized by a first broadcasting receiving apparatus reproducing the first video stream.

Another embodiment of the present invention provides a broadcasting transmitting method using a broadcasting transmitting apparatus. The broadcasting transmitting method includes: configuring one broadcasting channel as at least two video streams; generating a program map table (PMT) representing configuration information of a stream included within the broadcasting channel; setting a program type provided through the broadcasting channel within the PMT; generating a TS corresponding to the broadcasting channel by multiplexing the at least two video streams and the PMT; and transmitting the TS through a broadcasting network.

The program type may represent one of a DTV program, a 3DTV program, a UHDTV dedicated program, a DTV compatible 3DTV program, and a DTV compatible UHDTV program.

The PMT may further include program type details information.

The PMT may further include stream type values identifying the first video stream and the second video stream.

The generating of the PMT may include setting the stream type value, which is not recognized by a first broadcasting receiving apparatus reproducing the first video stream, as the stream type value of the second video stream.

Yet another embodiment of the present invention provides a broadcasting receiving apparatus. The broadcasting receiving apparatus includes a receiver, a demultiplexer, a signaling information extractor, and a video decoder. The receiver receives a transport stream (TS) corresponding to a broadcasting channel. The demultiplexer demultiplexes the TS to be separated into TS packets which correspond to at least two video streams and signaling information. The signaling information extractor identifies a program type of the broadcasting channel and stream type values of at least two video streams within the broadcasting channel from a program map table (PMT) of the TS packet corresponding to the signaling information. The video decoder selects and decodes the TS packet of the video stream corresponding to one of the stream type values of the at least two video streams based on the program type.

The program type may represent one of a DTV program, a 3DTV program, a UHDTV dedicated program, a DTV compatible 3DTV program, and a DTV compatible UHDTV program.

When the broadcasting receiving apparatus is a DTV receiving apparatus, the video decoder may select and decode a TS packet which corresponds to a video stream of a stream type value corresponding to a DTV stream type.

When the broadcasting receiving apparatus is a 3DTV or UHDTV receiving apparatus, the video decoder may select and decode a TS packet which corresponds to a video stream of a stream type value corresponding to a 3DTV or UHDTV stream type.

Still yet another embodiment of the present invention provides a broadcasting receiving method using a broadcasting transmitting apparatus. The broadcasting receiving method includes: receiving a transport stream (TS) corresponding to a broadcasting channel; demultiplexing the TS to be separated into TS packets which correspond to at least two video streams and signaling information; identifying a program type of the broadcasting channel and stream type values of at least two video streams within the broadcasting channel from a program map table (PMT) of the TS packet corresponding to the signaling information; and selecting and decoding the TS packet of the video stream corresponding to one of the stream type values of the at least two video streams based on the program type.

The program type may represent one of a DTV program, a 3DTV program, a UHDTV dedicated program, a DTV compatible 3DTV program, and a DTV compatible UHDTV program.

The decoding may include selecting and decoding a TS packet which corresponds to a video stream of a stream type value corresponding to a DTV stream type, when the broadcasting receiving apparatus is a DTV receiving apparatus.

The decoding may include selecting and decoding, by the video decoder, a TS packet which corresponds to a video stream of a stream type value corresponding to a 3DTV or UHDTV stream type, when the broadcasting receiving apparatus is a 3DTV or UHDTV receiving apparatus.

### BRIEF DESCRIPTION OF THE DRAWINGS

FIG. 1 is a diagram for conceptually describing an apparatus for transmitting and receiving broadcasting according to an exemplary embodiment of the present invention.

FIG. 2 is a diagram illustrating the broadcasting transmitting apparatus illustrated in FIG. 1.

FIG. 3 is a flowchart illustrating a broadcasting transmitting method using the broadcasting transmitting apparatus illustrated in FIG. 2.

FIG. 4 is a diagram illustrating the broadcasting receiving apparatus according to an exemplary embodiment of the present invention.

FIG. 5 is a flowchart illustrating a broadcasting receiving method using the broadcasting receiving apparatus illustrated in FIG. 4.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising” will be understood to imply the inclusion of stated elements but not the exclusion of any other elements.

Hereinafter, an apparatus and a method for transmitting and receiving broadcasting according to an exemplary embodiment of the present invention will be described in detail with reference to the accompanying drawings.

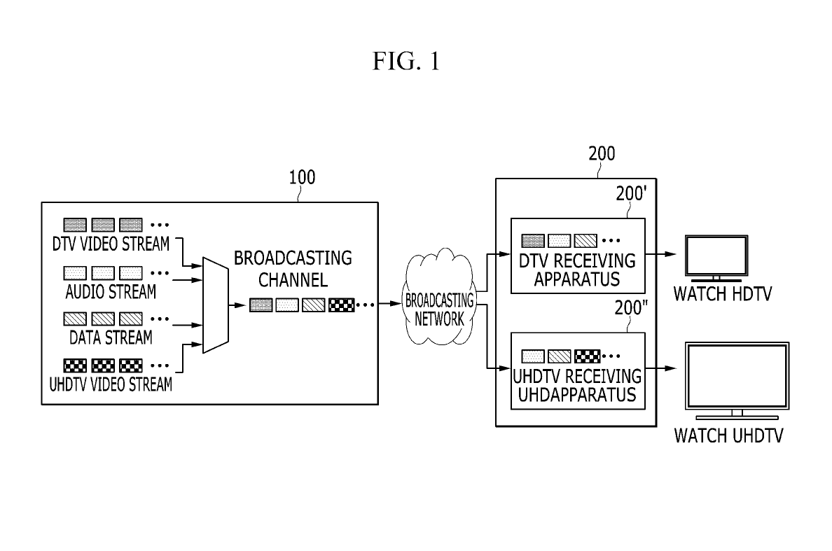

FIG. 1 is a diagram for conceptually describing an apparatus for transmitting and receiving broadcasting according to an exemplary embodiment of the present invention.

Referring to FIG. 1, a broadcasting transmitting apparatus 100 generates one transport stream (TS) corresponding to one broadcasting channel by multiplexing video, audio, and data streams into one data stream, and transmits the generated transport stream (TS) through a broadcasting network. In this case, the video stream may include the existing DTV video stream which is a reference image, and a 3DTV video stream or a UHDTV video stream which corresponds to an additional DTV video stream.

That is, the broadcasting transmitting apparatus 100 configures a broadcasting channel by adding the 3DTV or UHDTV video stream in addition to the DTV video stream, thereby providing more realistic and definitive new broadcasting service than the existing DTV broadcasting service.

A broadcasting receiving apparatus 200 receives the TS of the corresponding broadcasting channel, and demultiplexes the received TS to be separated into the video, audio, and data streams, and reproduces the video, audio, and data streams. The broadcasting receiving apparatus 200 may be a DTV receiving apparatus 200′ which may reproduce the DTV video stream, or a 3DTV or UHDTV receiving apparatus 200″ which may reproduce the 3DTV or UHDTV video stream.

The DTV receiving apparatus 200′ receives the TS of the corresponding broadcasting channel to provide the DTV broadcasting service. In this case, a viewer watches the DTV broadcasting service through the DTV receiving apparatus 200′. Further, the UHDTV receiving apparatus 200″ receives the TS of the corresponding broadcasting channel to provide the UHDTV broadcasting service. In this case, a viewer watches the DTV broadcasting service through the UHDTV receiving apparatus 200″.

As such, the broadcasting transmitting apparatus 100 transmits at least two video streams, for example, the existing DTV video stream and the UHDTV video stream which are added to one broadcasting channel, and the DTV receiving apparatus 200′ or the UHDTV receiving apparatus 200″ corresponding to the broadcasting receiving apparatus 200 receives the corresponding broadcasting channel to provide the DTV or UHDTV broadcasting service.

All data required for broadcasting as well as the video, audio, and data streams are transmitted by the TS defined in the ISO/IEC 13818-1 MPEG-2 system standard. The TS is a string of MPEG-2 TS packets which are composed of 188 bytes. Several broadcasting channels may be included within one TS, and configuration information of the broadcasting channel is transmitted to the broadcasting receiving apparatus 200 through a program association table (PAT) and a program map table (PMT). The PAT describes the configuration of the broadcasting channels included in the corresponding TS, and the PMT is a data structure which describes the configuration information on the video, audio, and data streams included in the corresponding broadcasting channel. Each of the TS packets has a packet identifier (PID) as an identifier which may identify each packet.

As illustrated in FIG. 1, when two video streams, that is, the DTV video stream and the UHDTV video stream, are included in one broadcasting channel, a DTV receiving apparatus 210 needs to be configured to not recognize the added UHDTV video stream, while a UHDTV receiving apparatus 200″ needs to be configured to recognize two video streams but selectively reproduce the UHDTV video stream. To this end, the broadcasting transmitting apparatus 100 according to the exemplary embodiment of the present invention needs to signal the configuration information of the channel and the information of the stream within the PMT. Hereinafter, a method for signaling the configuration information and the information of the stream within the PMT will be described.

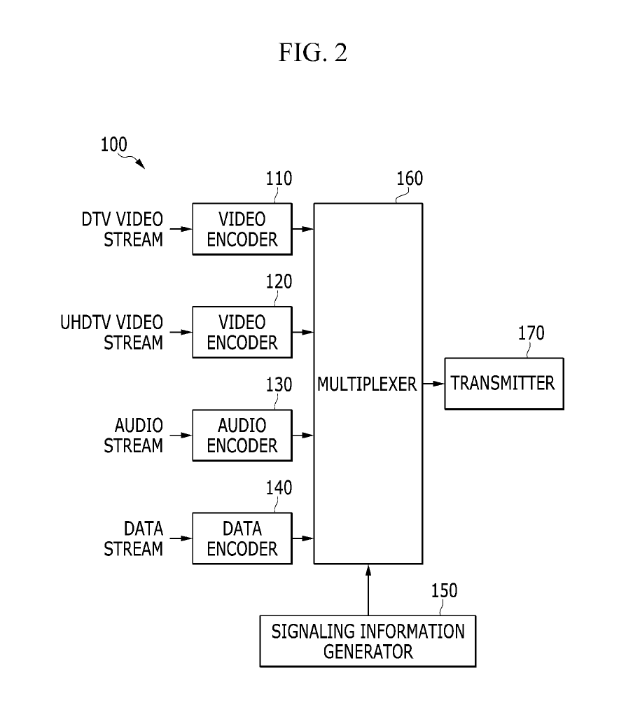

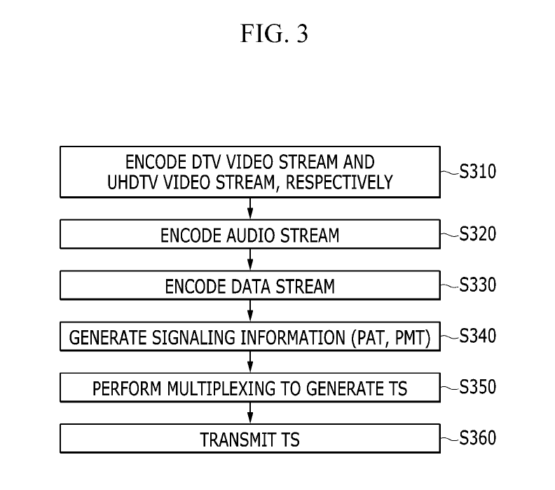

FIG. 2 is a diagram illustrating the broadcasting transmitting apparatus illustrated in FIG. 1, and FIG. 3 is a flowchart illustrating a broadcasting transmitting method using the broadcasting transmitting apparatus illustrated in FIG. 2.

Referring to FIG. 2, the broadcasting transmitting apparatus 100 includes a plurality of video encoders 110 and 120, an audio encoder 130, a data encoder 140, a signaling information generator 150, a multiplexer 160, and a transmitter 170.

Referring to FIG. 3, the plurality of video encoders 110 and 120 each encode the DTV video stream and the UHDTV video stream (S310), and output the encoded DTV video stream and UHDTV video stream to the multiplexer 160 as an MPEG-2 TS packet type.

The audio encoder 130 encodes the audio stream (S320) and outputs the encoded audio stream to the multiplexer 160 as the MPEG-2 TS packet type.

The data encoder 140 encodes the data stream (S330) and outputs the encoded data stream to the multiplexer 160 as the MPEG-2 TS packet type.

The signaling information generator 150 generates signaling information (S340) and outputs the signaling information to the multiplexer 160 as the MPEG-2 TS packet type. The signaling information may include the PAT and the PMT.

Table 1 shows the data structure of the PMT defined in the MPEG-2 system.

TABLE 1

| Grammar | Bit Number | Remarks |
|---|---|---|
| TS_program_map_section( ) { | | |
| table_id | 8 | |
| section_syntax_indicator | 1 | |
| ‘0’ | 1 | |
| Reserved | 2 | |
| section_length | 12 | |
| program_number | 16 | |
| Reserved | 2 | |
| version_number | 5 | |
| current_next_indicator | 1 | |
| section_number | 8 | |
| last_section_number | 8 | |
| Reserved | 3 | |
| PCR_PID | 13 | |
| Reserved | 4 | |
| program_info_length | 12 | |
| for (i=0; i<N; i++) { | | |
| descriptor( ) | | |
| } | | |
| for (i=0; i<N1; i++) { | | |
| stream_type | 8 | |
| Reserved | 3 | |
| elementary_PID | 13 | |
| Reserved | 4 | |
| ES_info_length | 12 | |
| for (i=0; i<N2; i++) { | | |
| descriptor( ) | | |
| } | | |
| } | | |
| CRC32 | 32 | |
| } | | |

As shown in Table 1, there is a descriptor loop after a program information length (program_info_length) field within the PMT.

The signaling information generator 150 places a program type descriptor in the descriptor loop to be able to identify the program type provided through the corresponding channel. The program type descriptor may be commonly used in any broadcasting service to be generated later. The program type means HDTV, 3DTV, UHDTV, and the like. The program type descriptor may be defined as shown in Table 2.

Table 2 shows a definition of each data field within the program type descriptor.

TABLE 2

| Syntax | Bit Number | Remarks |
|---|---|---|
| program_type_descriptor ( ) { | | |
| descriptor_tag | 8 | Future Definition |
| descriptor_length | 8 | |
| reserved | 4 | “111” |
| program_type | 4 | See Table 3 |
| type_info_details_length | 8 | |
| type_info_details( ) | 8 * N | User Definition |
| } | | |

Referring to Table 2, the program type descriptor includes a descriptor tag (descriptor_tag) field, a descriptor length (descriptor_length) field, a program type (program_type) field, a program type details length (type_info_details_length) field, and a program type details information [type_info_details( )] field. The descriptor_tag field is a field identifying a descriptor. The descriptor_length field is a field representing a length of the descriptor and represents a total byte number of fields, such as reserved, program_type field, type_info_details_length field, and type_info_details( ) field, which are located below the descriptor_length field. The program_type field commands the program type provided through the corresponding broadcasting channel, as defined in Table 3. The type_info_details_length field represents the total byte number of type_info_details( ) located below the corresponding field. When there is a need to specifically subdivide and identify the specific program type, the type_info_details( ) field defines and uses the corresponding field depending on the user definition.

Table 3 shows values of the program type.

TABLE 3

| Program Type | Description |
|---|---|
| 0000 | Reserved |
| 0001 | DTV (existing SDTV or HDTV) program |
| 0010 | 3DTV dedicated program: Non-compatible with |
| | existing receiver (for example, DTV) |
| 0011 | UHDTV dedicated program: Non-compatible with |
| | existing receiver |
| 0100 | DTV compatible 3DTV program: Compatible with |
| | existing receiver |
| 0101 | DTV compatible UHDTV program: Compatible with |
| | existing receiver |
| 0110-1111 | Reserved for future use |

As illustrated in Table 3, the signaling information generator 150 identifies the program type, such that the broadcasting receiving apparatus 200 uses the program_type field to be able to understand and reproduce which type of program is transmitted at the present point of the corresponding broadcasting channel.

Further, the broadcasting receiving apparatus 200 uses the type_info_details( ) field to be able to specifically identify the program. For example, when the program type is “0011” and the UHDTV dedicated program, it is possible for a user to define and identify a new field, such as “UHDTV_type”, in the type_info_details( ) as illustrated in Table 4 so that 4K-UHDTV (resolution four times higher than HD) or 8K-UHDTV (resolution sixteen times higher than HD) may be identified within the UHDTV.

TABLE 4

| Syntax | Bit Number | Remarks |
|---|---|---|
| type_info_details( ){ | | |
| reserved | 4 | “111” |
| UHDTV_type | 4 | |

}

As illustrated in FIG. 1, when two video streams are present within the corresponding channel, the signaling information generator 150 sets the signaling information in the PMT to be able to identify each stream.

The signaling information generator 150 provides the information on each stream from a for loop below a first descriptor loop in the PMT of Table 1. The corresponding for loop includes a stream_type field, a stream identifier (elementary_PID) field, and the descriptor loop. The stream_type field represents a type and a compression method of the stream included in the TS packet having a PID value which is represented in the next stream identifier (elementary_PID) field. The elementary_PID field represents the identifier of the stream, that is, the PID value of the packet including the corresponding stream.

Basically, to identify the video, audio, and data streams in the MPEG-2 system standard, stream_type values are defined. The stream_type values are each different depending on the compression method of the video and audio streams, and even in the case of the data stream, are different depending on the transmitted data format. Most of the video compression methods which are used in the domestic and international DTV broadcasting standard are an MPEG-2 and MPEG-4 part10 (AVC: Advanced Video Coding), and one of the two compression methods is selected, or otherwise both of the two compression methods are defined. As the stream_type value, the MPEG-2 video uses 0x02 and the AVC video uses 0x1B.

To keep the compatibility with the existing DTV, as the stream_type value of the DTV video stream, the signaling information generator 150 uses 0x02 in the case of the MPEG-2 video, uses 0x1B in the case of the AVC video, and uses the stream_type value, which may not be recognized by the DTV receiving apparatus 210, as illustrated in Table 5 in the case of the video stream for the added UHDTV and 3DTV services or other services. When the stream_type value which may not be recognized by the DTV receiving apparatus 210 is applied, there is a possibility of a malfunction due to the added video stream. Since the value which may not be recognized by the DTV receiving apparatus 210 is defined to be disregarded in the MPEG-2 system standard, the malfunction does not occur even though the stream_type value which may not be recognized by the DTV receiving apparatus 210 is received.

TABLE 5

| Stream Type | Description |
|---|---|
| 0xA0 | AVC coding 3DTV video (side-by-side, top-and-bottom |
| | format) stream |
| 0xA1 | HEVC coding 3DTV video (side-by-side, top-and-bottom |
| | format) stream |
| 0xA2 | AVC coding UHDTV video stream |
| 0xA3 | HEVC coding UHDTV video stream |

In Table 5, the stream_type value is a value which may be later changed to any predetermined value, and the HEVC coding means the video encoding method which is proposed as a high-efficiency video compression encoding standard in the latest MPEH-H. Further, the case of the 3DTV video stream corresponds to a case of a frame compatible format (for example, side-by-side and top-and-bottom formats) which is not compatible with the existing DTV broadcasting service.

In addition to the PAT and the PMT defined in the MPEG-2 system, the data structure for each broadcasting standard organization to provide the configuration information of the channel is defined in the digital broadcasting, and in particular, a program and system information protocol (PSIP) defined in Advanced Television System Committee (ATSC) and service information standard defined in Society of Cable Telecommunications Engineers (SCTE) are used in Korea and North America. In the PSIP, the information on the service channel is provided to the broadcasting receiving apparatus 200 through a virtual channel table (VCT). In addition, in the SI, the service channel information is provided to the broadcasting receiving apparatus 200 through a short form-VCT (S-VCT) or a long form-VCT (L-VCT). In this case, the program type descriptor of Table 2 is transmitted while included in descriptor loops for each virtual channel of the VCT, the S-VCT, and the L-VCT. Further, to inform a stream configuration for each channel in the VCT and L-VCT, the stream_type field included in an inserted service location descriptor uses values shown in Table 5 to command the video streams of the added UHDTV and 3DTV services or other services so as to provide the compatibility of the corresponding channel with the existing DTV receiving apparatus.

The multiplexer 160 multiplexes the TS packets which correspond to the DTV video stream, the UHDTV video stream, the audio stream, the data stream, and the signaling information to generate one TS corresponding to one broadcasting channel (S350).

The transmitter 170 transmits the TS multiplexed by the multiplexer 160 through the broadcasting network (S360).

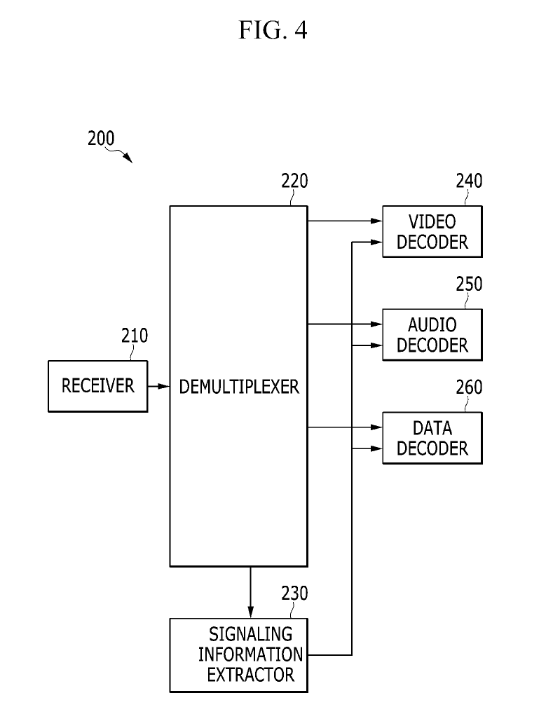

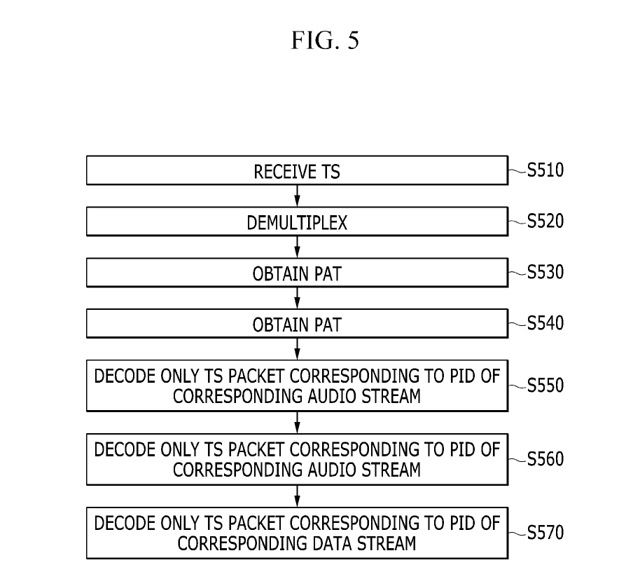

FIG. 4 is a diagram illustrating the broadcasting receiving apparatus according to an exemplary embodiment of the present invention and FIG. 5 is a flowchart illustrating a broadcasting receiving method using the broadcasting receiving apparatus illustrated in FIG. 4.

Referring to FIG. 4, the broadcasting receiving apparatus 200 includes a receiver 210, a demultiplexer 220, a signaling information extractor 230, a video decoder 240, an audio decoder 250, and a data encoder 260.

Referring to FIG. 5, the receiver 210 receives the TS corresponding to the broadcasting channel (S510) and transmits the received TS to the demultiplexer 220.

The demultiplexer 220 demultiplexes the TS to be separated into the TS packets which correspond to the DTV video stream, the UHDTV video stream, the audio stream, the data stream, and the signaling information (S520). The demultiplexer 220 outputs the TS packet corresponding to the DTV video stream and the UHDTV video stream to the video decoder 240, outputs the TS packet corresponding to the audio stream to the audio decoder 250, and outputs the TS packet corresponding to the data stream to the data encoder 260. Further, the demultiplexer 220 outputs the TS packet corresponding to the signaling information to the signaling information extractor 230.

The signaling information extractor 230 first searches for the TS packet including the PAT from the TS packet corresponding to the signaling information to obtain the PAT (S530). The TS packet including the PAT has 0 as the PID value. Therefore, the signaling information extractor 230 searches for the packet having the PID value of 0 to be able to obtain the PAT.

Further, the signaling information extractor 230 may determine which broadcasting channels are present in the corresponding TS from the obtained PAT, and may determine the PID of the TS packet including the PMTs for each channel to obtain the configuration information on each broadcasting channel.

The signaling information extractor 230 obtains the PMT of the corresponding broadcasting channel through the PID information of the PMT obtained from the PAT (S540), and obtains the configuration information on the video, audio, and data streams within the corresponding broadcasting channel and the PID information of the TS packet transmitted by each stream through the obtained PMT.

The signaling information extractor 230 transmits the configuration information on the video, audio, and data streams within the broadcasting channel and the PID information of the TS packet transmitted by each stream to the video decoder 240, the audio decoder 250, and the data encoder 260, respectively.

The video decoder 240 decodes and outputs only the TS packet corresponding to the PID which corresponds to the video stream transmitted by the signaling information extractor 230 (S550). In this case, when the broadcasting receiving apparatus 200 is the DTV receiving apparatus, the video decoder 240 selects and decodes the TS packet of the video stream corresponding to the DTV stream_type which may be recognized by the video decoder 240. When the broadcasting receiving apparatus 200 is the UHDTV receiving apparatus, the video decoder 240 may determine both of the DTV stream_type and the UHDTV stream_type, but may select and decode the TS packet corresponding to the UHDTV video stream among the DTV stream_type and the UHDTV stream_type.

The audio decoder 250 decodes and outputs only the TS packet corresponding to the PID which corresponds to the audio stream transmitted by the signaling information extractor 230 (S560).

The data encoder 260 decodes and outputs only the TS packet corresponding to the PID which corresponds to the data stream transmitted by the signaling information extractor 230 (S570).

As a result, the broadcasting receiving apparatus 200 filters only the corresponding packets based on the configuration information of the broadcasting channel obtained from the PMT and the PID information corresponding to each of the video, audio, and data streams to reproduce the video/audio streams.

According to the exemplary embodiments of the present invention, it is possible to provide the new broadcasting services, such as the UHDTV or the 3DTV while being compatible with the existing DTV receiving apparatus, by configuring the channel by adding the UHDTV video stream or the 3DTV stream corresponding to the existing DTV video stream to the existing DTV video stream and defining the stream_type value, which may not be recognized by the existing DTV receiving apparatus, so as to identify the descriptor for identifying the program type from the DTV video stream and the added video stream.

Further, it is possible to very easily provide the backward compatibility which may be the biggest problem in applying the new broadcasting service, thereby greatly contributing to the activation of the new broadcasting service and the activation of the related equipment and media industry.

The exemplary embodiments of the present invention are not implemented only by the apparatus and/or method as described above, but may be implemented by programs realizing the functions corresponding to the configuration of the exemplary embodiments of the present invention or a recording medium recorded with the programs, which may be readily implemented by a person having ordinary skill in the art to which the present invention pertains from the description of the foregoing exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A broadcasting transmitting apparatus, comprising:
a first video encoder encoding a first video stream to be output as a transport stream (TS) packet;
a second video encoder encoding a second video stream to be output as a TS packet;
a signaling information generator generating signaling information including a program association table (PAT) which represents configuration information of a broadcasting channel and a program map table (PMT) which represents configuration information of a stream included in the broadcasting channel to be output as a TS packet;
a multiplexer multiplexing the TS packets, which correspond to the first video stream, the second video stream, and the signaling information, to generate a TS corresponding to the broadcasting channel; and
a transmitter transmitting the TS through a broadcasting network, wherein the PMT includes a program type provided through the broadcasting channel.

2. The apparatus of claim 1, wherein
the program type represents one of a DTV program, a 3DTV program, a UHDTV dedicated program, a DTV compatible 3DTV program, and a DTV compatible UHDTV program.

3. The apparatus of claim 1, wherein
the PMT includes a descriptor loop,
the descriptor loop includes a program type descriptor, and
the program type descriptor includes a program type field representing the program type.

4. The apparatus of claim 3, wherein
the program type descriptor further includes a program type details information field representing program type details information.

5. The apparatus of claim 1, wherein
the PMT includes stream type values identifying the first video stream and the second video stream, and
the signaling information generator sets the stream type value of the second video stream as a stream type value which is not recognized by a first broadcasting receiving apparatus reproducing the first video stream.

6. A broadcasting transmitting method using a broadcasting transmitting apparatus, comprising:
configuring one broadcasting channel as at least two video streams;
generating a program map table (PMT) representing configuration information of a stream included within the broadcasting channel;
setting a program type provided through the broadcasting channel within the PMT;
generating a TS corresponding to the broadcasting channel by multiplexing the at least two video streams and the PMT; and
transmitting the TS through a broadcasting network.

7. The method of claim 6, wherein
the program type represents one of a DTV program, a 3DTV program, a UHDTV dedicated program, a DTV compatible 3DTV program, and a DTV compatible UHDTV program.

8. The method of claim 6, wherein
the PMT further includes program type details information.

9. The method of claim 6, wherein
the PMT further includes stream type values identifying the first video stream and the second video stream.

10. The method of claim 9, wherein
the generating of the PMT includes setting the stream type value, which is not recognized by a first broadcasting receiving apparatus reproducing the first video stream, as the stream type value of the second video stream.

11. A broadcasting receiving apparatus, comprising:
a receiver receiving a transport stream (TS) corresponding to a broadcasting channel;
a demultiplexer demultiplexing the TS to be separated into TS packets which correspond to at least two video streams and signaling information;
a signaling information extractor identifying a program type of the broadcasting channel and stream type values of at least two video streams within the broadcasting channel from a program map table (PMT) of the TS packet corresponding to the signaling information; and
a video decoder selecting and decoding the TS packet of the video stream corresponding to one of the stream type values of the at least two video streams based on the program type.

12. The apparatus of claim 11, wherein
the program type represents one of a DTV program, a 3DTV program, a UHDTV dedicated program, a DTV compatible 3DTV program, and a DTV compatible UHDTV program.

13. The apparatus of claim 11, wherein
when the broadcasting receiving apparatus is a DTV receiving apparatus, the video decoder selects and decodes a TS packet which corresponds to a video stream of a stream type value corresponding to a DTV stream type.

14. The apparatus of claim 11, wherein
when the broadcasting receiving apparatus is a 3DTV or UHDTV receiving apparatus, the video decoder selects and decodes a TS packet which corresponds to a video stream of a stream type value corresponding to a 3DTV or UHDTV stream type.

15. A broadcasting receiving method using a broadcasting receiving apparatus, comprising:
receiving a transport stream (TS) corresponding to a broadcasting channel;
demultiplexing the TS to be separated into TS packets which correspond to at least two video streams and signaling information;
identifying a program type of the broadcasting channel and stream type values of at least two video streams within the broadcasting channel from a program map table (PMT) of the TS packet corresponding to the signaling information; and
selecting and decoding the TS packet of the video stream corresponding to one of the stream type values of the at least two video streams based on the program type.

16. The method of claim 15, wherein
the program type represents one of a DTV program, a 3DTV program, a UHDTV dedicated program, a DTV compatible 3DTV program, and a DTV compatible UHDTV program.

17. The method of claim 15, wherein
the decoding includes selecting and decoding a TS packet which corresponds to a video stream of a stream type value corresponding to a DTV stream type, when the broadcasting receiving apparatus is a DTV receiving apparatus.

18. The method of claim 15, wherein
the decoding includes selecting and decoding, by the video decoder, a TS packet which corresponds to a video stream of a stream type value corresponding to a 3DTV or UHDTV stream type, when the broadcasting receiving apparatus is a 3DTV or UHDTV receiving apparatus.
